(19) United States
(12) Patent Application Publication
(10) Pub. No.: US 2018/0211607 A1
(43) Pub. Date: Jul. 26, 2018

(54) SYSTEM FOR AUTOMATICALLY ADJUSTING PICTURE SETTINGS OF AN OUTDOOR TELEVISION IN RESPONSE TO CHANGES IN AMBIENT CONDITIONS

(71) Applicant: Séura, Inc., Green Bay, WI (US)

(72) Inventors: Ryan J. Kabacinski, Green Bay, WI (US); Robert J. Elsing, Green Bay, WI (US); Yoon Namkung, Seoul (KR)

(21) Appl. No.: 15/414,372

(22) Filed: Jan. 24, 2017

(51) Int. Cl. G09G 3/34; G09G 3/36

(52) U.S. Cl. CPC G09G 3/3406; G09G 2360/144; G09G 2320/02; G09G 3/36

(57) ABSTRACT

An outdoor television includes a light monitoring sensor that is configured to measure an ambient light intensity, the light monitoring sensor is in operable communication with a microprocessor, a display is in operable communication with the microprocessor, and a video source is in operable communication with the microprocessor. In response to the measured ambient light intensity, the microprocessor adjusts at least one picture setting of the display, the at least one setting picture setting including one of a contrast, a sharpness, a display brightness, a tint, or a color.

### FIELD OF THE INVENTION

The present invention relates to a system for automatically adjusting one or more picture settings of an outdoor television. More specifically, the system automatically adjusts one or more picture settings in response to changes in environmental conditions that surround the outdoor television.

### BACKGROUND

Outdoor televisions are subject to a much wider range of environmental conditions than indoor televisions. In addition to confronting rain, snow, ice, dew, or other moisture that can damage electronic components, outdoor televisions have to account for a wide range of environmental temperatures (e.g., below 32° F. to exceeding 100° F., etc.), wind, dust, insects, and other climate related factors. To account for these wide ranging environmental conditions, outdoor televisions are generally designed differently than indoor televisions.

Outdoor televisions often have to operate differently than indoor televisions due to environmental conditions. For example, in certain outdoor applications it is necessary for an outdoor television to operate in sunlight, which is a high ambient light condition. The high intensity of sunlight can make it difficult to see a viewable image on the television. Manufacturers have made attempts to improve the viewability of the outdoor television in high ambient light conditions, but the attempts have drawbacks. For example, manufacturers have applied anti-glare or anti-reflective coatings to the television screen. While these coatings do improve viewability in high ambient light conditions, these coatings degrade picture quality, including sharpness and brightness.

As another example, manufacturers preset color gains and/or picture mode settings of outdoor televisions to higher levels than the typical indoor television in an attempt to increase brightness to compensate for high ambient light conditions. Increasing the picture setting brightness is accomplished by exciting red, green and blue pixels across all percentages of grayscale. Often, manufacturers increase certain colors so much that it creates an unbalanced color image, and in extreme cases “clipping.” Clipping occurs when further pixel excitation does not produce any increase in light output. While exciting pixels does increase the brightness level, excessive excitation of pixels degrades color accuracy and color balance of the image, resulting in a degradation of picture quality (e.g., a loss of shade variation, image detail, and image quality resulting in a less life-like picture quality, etc.). Some manufacturers attempt to compensate for changes in ambient light conditions by further adjusting the backlight. For example, in lower ambient light conditions, the intensity of light generated by the backlight can be reduced, resulting in a decrease in the overall brightness of the outdoor television. However, this reduction in backlight brightness does not resolve the degradation of picture quality caused by excessive excitation of pixels, as the image still encounters the same loss of shade variation, image detail, and image quality because image quality is independent of backlight control.

Accordingly, there is a need for an outdoor television that improves picture viewability in high ambient light conditions (e.g., in high sunlight or direct sunlight conditions, etc.) while limiting adverse effects to image quality. In addition, there is a need for an outdoor television that will automatically adjust the picture based on a measured ambient light to improve viewability in different lighting conditions while limiting adverse effects to image quality.

### SUMMARY

In one embodiment, the disclosure provides an outdoor television that includes a light monitoring sensor that is configured to measure an ambient light intensity, the light monitoring sensor is in operable communication with a microprocessor. A display is in operable communication with the microprocessor, and a video source is in operable communication with the microprocessor. In response to the measured ambient light intensity, the microprocessor adjusts at least one picture setting of the display, the at least one setting picture setting including one of a contrast, a sharpness, a display brightness, a tint, or a color.

In another embodiment, the disclosure provides an outdoor television that includes a light monitoring sensor that is configured to measure an ambient light intensity, the light monitoring sensor is in operable communication with a microprocessor. A display is in operable communication with the microprocessor, and a video source in operable communication with the microprocessor. In response to the measured ambient light intensity, the microprocessor adjusts at least one picture setting of the display and adjusts the brightness of the display.

Other aspects of the invention will become apparent by consideration of the detailed description and accompanying drawings.

### BRIEF DESCRIPTION OF THE DRAWINGS

FIG. 1 is a front view of an embodiment of an outdoor television.

FIG. 2 is a back view of the outdoor television of FIG. 1.

FIG. 3 is a first side view of the outdoor television of FIG. 1, taken along line 3-3 of FIG. 2.

FIG. 4 is a schematic layout of the outdoor television shown in FIG. 1 illustrating components for implementing an automatic picture adjustment system.

FIG. 5A is a flow diagram of a first portion of an embodiment of the automatic picture adjustment system that is configured to detent ambient light and in response automatically adjust one or more picture settings of a display of the outdoor television of FIG. 1.

FIG. 5B is a flow diagram of a second portion of an embodiment of the automatic picture adjustment system that is configured to detent ambient light and in response automatically adjust one or more picture settings of a display of the outdoor television of FIG. 1.

FIG. 5C is a flow diagram of a third portion of an embodiment of the automatic picture adjustment system that is configured to detent ambient light and in response automatically adjust one or more picture settings of a display of the outdoor television of FIG. 1.

FIG. 5D is a flow diagram of an alternative third portion of an embodiment of the automatic picture adjustment system for use with an Ultra-High Definition version of the outdoor television of FIG. 1.

FIG. 6 is a graph illustrating performance of the automatic picture adjustment system of FIGS. 5A-5C in association with the outdoor television of FIG. 1.

Before any embodiments of the disclosure are explained in detail, it should be understood that the disclosure is not limited in its application to the details or construction and the arrangement of components as set forth in the following description or as illustrated in the drawings. The disclosure is capable of supporting other embodiments and of being practiced or of being carried out in various ways. It should be understood that the description of specific embodiments is not intended to limit the disclosure from covering all modifications, equivalents and alternatives falling within the spirit and scope of the disclosure. Also, it is to be understood that the phraseology and terminology used herein is for the purpose of description and should not be regarded as limiting.

### DETAILED DESCRIPTION

The invention illustrated in the figures and disclosed herein is generally directed to an outdoor television 10 that includes an automatic picture adjustment system 100. The automatic picture adjustment system 100 detects light conditions (or ambient light) in an environment that surrounds the outdoor television 10, and in response to the detected light conditions, automatically adjusts one or more picture settings of the display. The adjustments to the display advantageously increase brightness (or image brightness or picture brightness) in high ambient light conditions, while limiting adverse effects on picture quality (or image quality) in lower ambient light conditions. For example, in high ambient light conditions (e.g., bright conditions, etc.), such as when the outdoor television 10 is in direct sunlight, the automatic picture adjustment system 100 detects the high ambient light conditions and adjusts at least one picture setting, such as a backlight brightness. Based on the detected ambient light conditions, the automatic picture adjustment system 100 can increase backlight (in bright conditions) or decrease backlight (in less bright conditions) to adjust a brightness of the display in order to improve viewability. As another example, in lower ambient light conditions, such as when the outdoor television 10 is not in direct sunlight (e.g., it is overcast, nighttime, etc.), the automatic picture adjustment system 100 detects the ambient light conditions and adjusts at least one picture setting in order to improve viewability while minimizing adverse effects on image quality. For example, the system 100 can adjust one or more of picture contrast, display brightness, sharpness, tint, and/or color. The automatic picture adjustment system 100 can also systematically detect ambient light conditions and automatically implement adjustments to one or more picture settings of the display in response to changing ambient light conditions.

For ease of discussion and understanding, the following detailed description will refer to and illustrate the outdoor television 10 that incorporates the automatic picture adjustment system 100. The outdoor television 10 shown and described herein is a television suitable to operate in outdoor environmental conditions. However, it should be appreciated that the outdoor television 10 is provided for purposes of illustration of the automatic picture adjustment system 100 disclosed herein. The automatic picture adjustment system 100 is not limited for use with an outdoor television 10, and can be used in association with any suitable display, including, but not limited to, an indoor television, a computer monitor, or any other display device where it is desired to adjust one or more picture settings of the display in response to changing light conditions.

In addition, the outdoor television 10 disclosed herein includes a liquid crystal display (or LCD). It should be appreciated that the liquid crystal display is provided for purposes of illustration, and is not intended to be limiting. The automatic picture adjustment system 100 disclosed herein can generally be used in associated with any suitable display technology, including, but not limited to, a light-emitting diode display (or LED), a plasma display panel (or PDP), an organic light-emitting diode display (OLED), or any other known or future developed display technology.

It should also be appreciated that the terms “brightness,” “brightness level”, and/or “brightness of the display” refer to an amount (or level) of luminance emitted by the display (e.g., as brightness increases, luminance of the display increases; as brightness decreases, luminance of the display decreases, etc.). In certain displays, such as an LCD, brightness can be adjusted by changing an intensity of light emitted by a backlight and/or by changing an amount of light that can be transmitted (or passes) through the display. The terms “backlight intensity” and/or “backlight brightness” refer to the amount of light emitted by the backlight. As backlight intensity or backlight brightness increase, the corresponding amount (or intensity) of light emitted by the backlight increases. Similarly, as backlight intensity or backlight brightness decrease, the corresponding amount (or intensity) of light emitted by the backlight decreases. The terms “display brightness” and/or “picture setting brightness” refer to the amount of light that is allowed to be transmitted through the display. The display brightness or picture setting brightness is adjustable as a picture setting, and adjusts the amount (or intensity) of light that can pass through (or is emitted) by the display. As display brightness or picture setting brightness increase, the corresponding amount (or intensity) of light that passes through (or emitted) by the display increases. Similarly, as display brightness or picture setting brightness decrease, the corresponding amount (or intensity) of light that passes through (or emitted) by the display decreases.

The term calculating (or calculate and calculated), as used herein, is used with reference to calculations performed by the disclosed system. The term includes calculating, determining, and estimating.

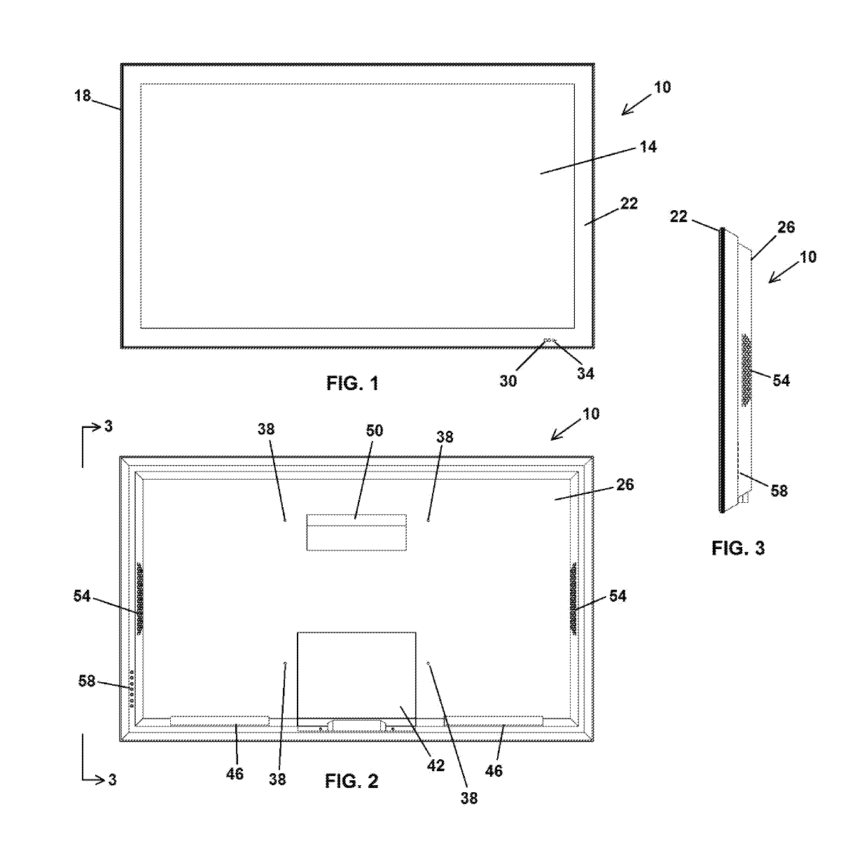

Referring now to the figures, FIGS. 1-3 illustrate an embodiment of an outdoor television 10. As illustrated in FIG. 1, the outdoor television 10 includes a display 14 and a housing 18. The housing 18 encases the display 14. The housing 18 can include a first or front portion 22 that is coupled to a second or back portion 26 (shown in FIG. 3). The first and second portions 22, 26 can be coupled to form a clamshell arrangement and define the housing 18. The housing 18 can be formed of a metal exterior, and further can be a powder-coated metal. In addition, the housing 18 can include a transparent tempered safety glass that overlaps (or is formed with) the display 14. This allows the housing 18 to provide a weather resistant barrier between outdoor environmental conditions and electrical components required to operate the outdoor television 10.

The housing 18 includes a signal receiver 30 and a light monitoring sensor 34. As shown in FIG. 1, the signal receiver 22 is positioned in the first portion 22 of the housing 18 and is an infrared (IR) receiver that is configured to receive a signal from a remote device, such as a remote control. The remote device is configured to provide commands to operate the outdoor television 10. The light monitoring sensor 34 is configured to monitor ambient light. In the illustrated embodiment, the light monitoring sensor 34 is a photocell 34. However, in other embodiments, the light monitoring sensor can be any suitable device that measures and/or monitors the amount of light in the environment around the outdoor television 10. For example, the light monitoring sensor 34 can be a photo resistor, a photodiode, or any other suitable light sensing device.

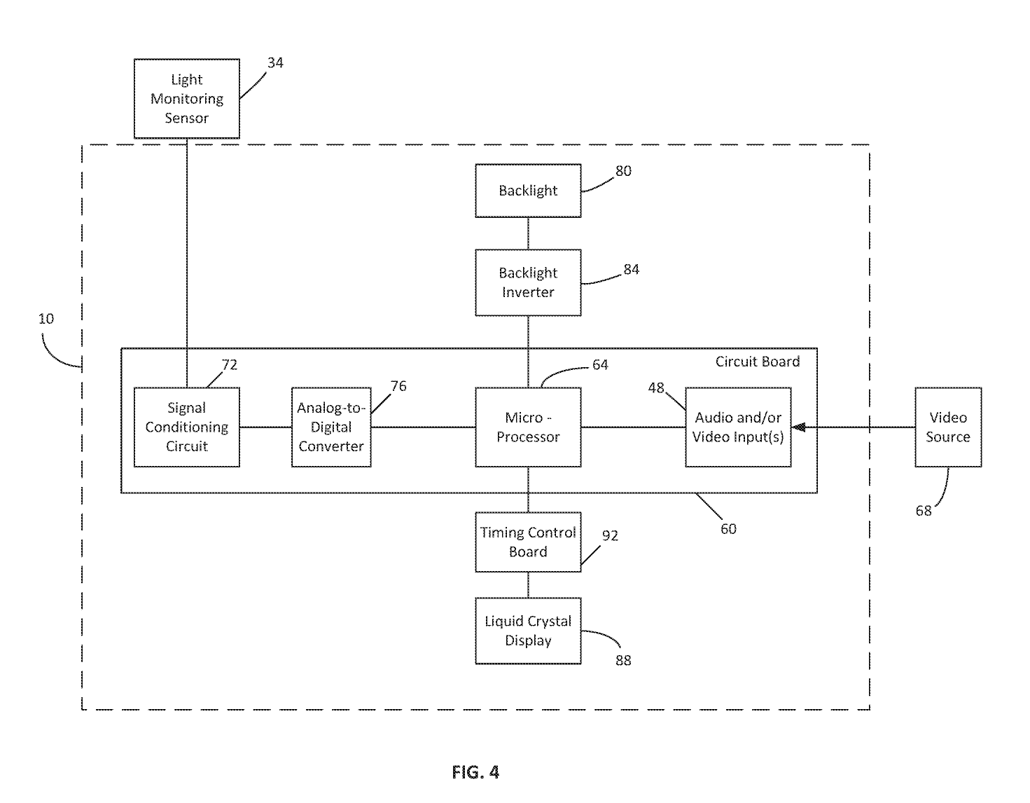

Referring now to FIG. 2, the back portion 26 includes a plurality of apertures 38 that define a mounting interface. In the illustrated embodiment, the apertures 38 define an M6 VESA (or Video Electronics Standard Association) mounting pattern. In other embodiments, the apertures 38 can be sized and/or arranged to form any suitable display mounting interface. The back portion 26 also includes a removable cover 42 that is positioned to shield one or more audio or video inputs 48 (e.g., high-definition multimedia interface (HDMI) ports, a coaxial cable port, S-video port, VGA port, A/V inputs, composite video, component video, etc.), shown in FIG. 4. The back portion 26 defines an air intake 46 positioned towards the bottom of the back portion 26, and an exhaust port 50 positioned within the VESA mounting interface. The air intake 46 provides air access to cool the outdoor television 10 before it is discharged through the exhaust portion 50. In the illustrated embodiment, a plurality of air intakes 46 and a single exhaust port 50 are defined by the back portion 26. In other embodiments, any suitable number of air intakes 46 and/or exhaust ports 50 can be positioned at any suitable or desired location on the housing 18. With reference now to FIGS. 2-3, the back portion 26 includes speakers 54 to provide sound, and a control panel 54 to provide a user control and/or adjustment of the outdoor television 10.

FIG. 4 illustrates a schematic view of a controller and associated components of the outdoor television 10 for use with the automatic picture adjustment system 100. The outdoor television 10 includes a circuit board 60 (or main circuit board 60) that is housed within the outdoor television 10. The circuit board 60 can be a printed circuit board (or PCB) that carries, or otherwise includes, a microprocessor 64 (or main microprocessor 64). The one or more audio and/or video ports 48 can be attached or otherwise mounted to the circuit board 60. Each audio and/or video port 48 is also in operable communication with the microprocessor 64. A video source 68 is in communication with one of the video ports 48 to provide a video signal to the outdoor television 10. The video signal is communicated from the video source 68 by a desired or suitable media type (e.g., HDMI, composite video, component video, VGA, etc.) to the associated video port 48. The video port 48 then routes the video signal to the microprocessor 64 through the appropriate circuitry provided on the circuit board 60.

The light monitoring sensor 34 is in operable communication with the microprocessor 64. The light monitoring sensor 34 is positioned relative to the outdoor television 10 such that it is configured to detect ambient light conditions. In the illustrated embodiment, the light monitoring sensor 34 is a photocell 34. The photocell 34 generates an electrical resistance that increases as the intensity of ambient light increases. Accordingly, the more intense (or bright) the light measured by the photocell 34, the greater the generated electrical resistance. Similarly, the less intense (or less light or dimmer) the light measured by the photocell 34, the lower the generated electrical resistance. The photocell 34 is in communication with a signal conditioning circuit 72 that is positioned on the circuit board 60. The signal conditioning circuit 72 receives the resistance generated by the photocell 34, and then converts the resistance into a voltage. An analog-to-digital convertor 76 is also positioned on the circuit board 60, and is in communication with the signal conditioning circuit 72. The analog-to-digital convertor 76 receives (or samples) the voltage generated by the signal conditioning circuit 72, and converts the voltage into an 8-bit digital value. The microprocessor 64 is in communication with the analog-to-digital convertor 76, and receives the 8-bit digital value from the analog-to-digital convertor 76.

Based on one or more steps of the automatic picture adjustment system 100, which is discussed in additional detail below, the microprocessor 64 uses the 8-bit digital value to adjust the backlight brightness and/or to adjust at least one picture setting.

To adjust the backlight brightness, the microprocessor 64 is in communication with a backlight 84. More specifically, the microprocessor 64 is in communication with a backlight inverter 84, which is in turn operably connected to the backlight 80. A control signal to brighten or dim the backlight 80 (collectively a “dimming control signal”) is generated by the microprocessor 64 and sent to the backlight inverter 84. The backlight inverter 84 receives the dimming control signal, and in turn adjusts power applied to the backlight 80 (e.g., increasing power increases backlight and brightens, decreasing power decreases backlight and dims).

The microprocessor 64 is also in communication with the display, illustrated as a liquid crystal display 88. More specifically, the microprocessor 64 is in communication with a timing control board 92, which is in turn operably connected to the display 88. The microprocessor 64 transmits the video signal from the video input 48 to the timing control board 92. The timing control board 92 converts the video signal into an appropriate format for control of the liquid crystals in the display 88. To adjust at least one picture setting, the microprocessor 64 adjusts the one or more picture settings (or picture mode settings), and applies the settings to the video signal transmitted to the timing control board 92. The timing control board 92 then implements the adjusted one or more picture settings during conversion of the video signal to the format for control of the liquid crystals in the display 88.

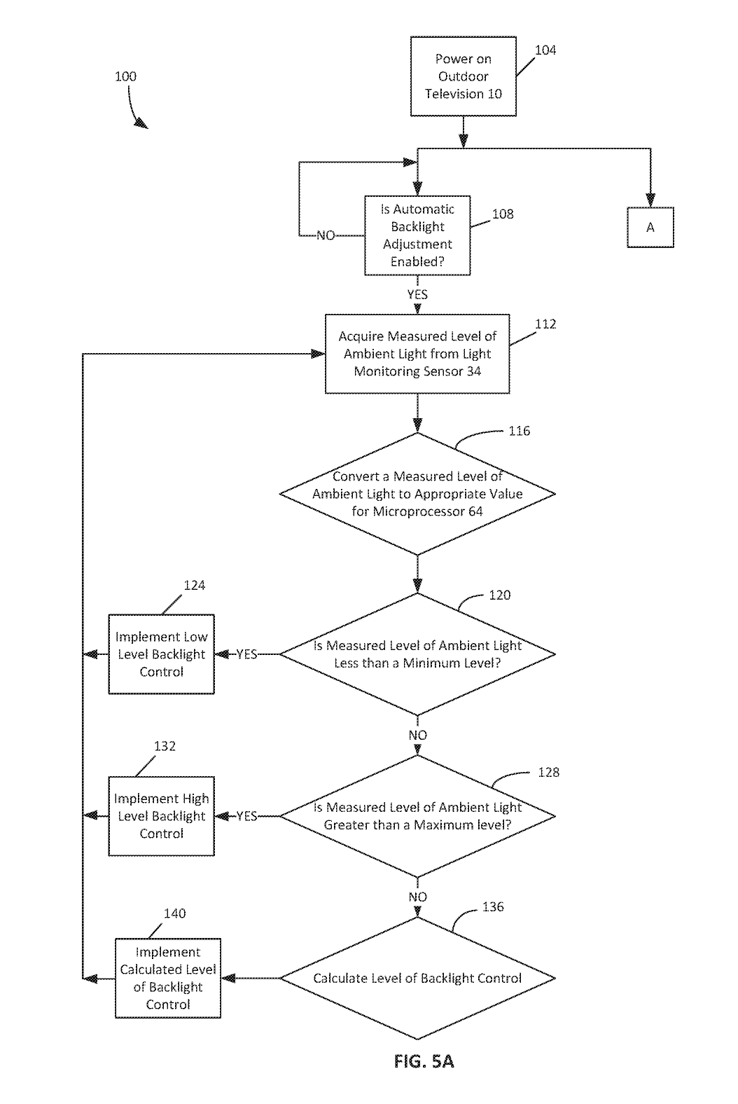

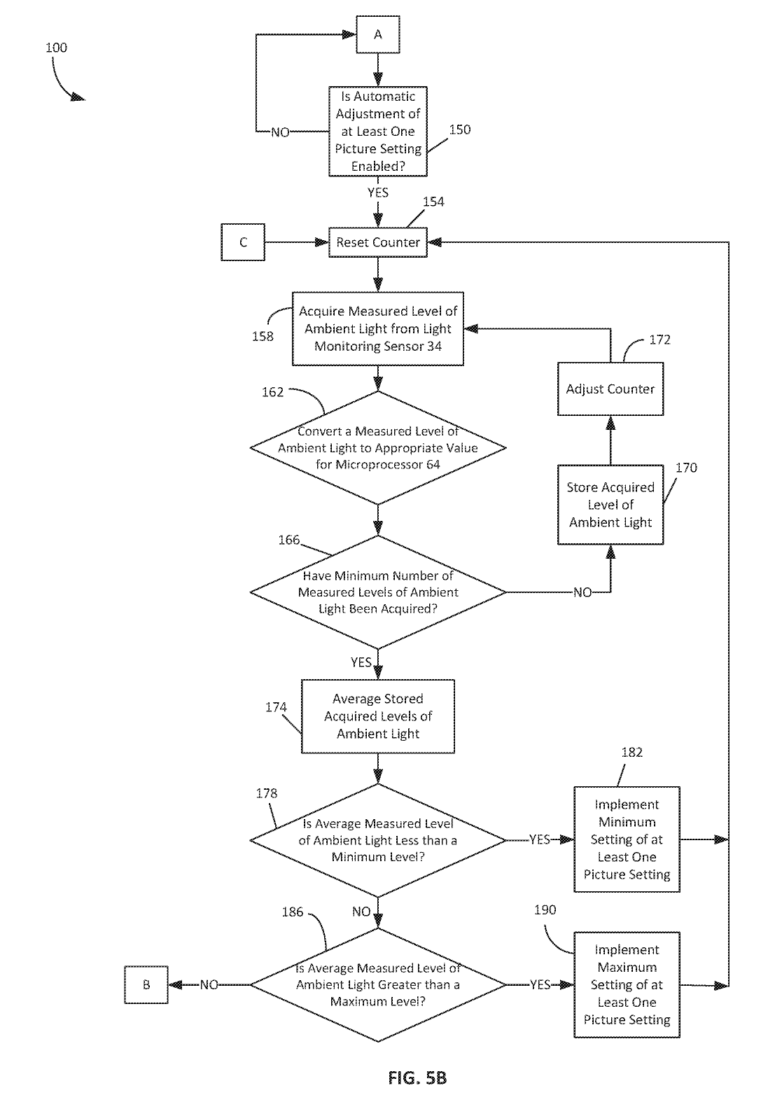

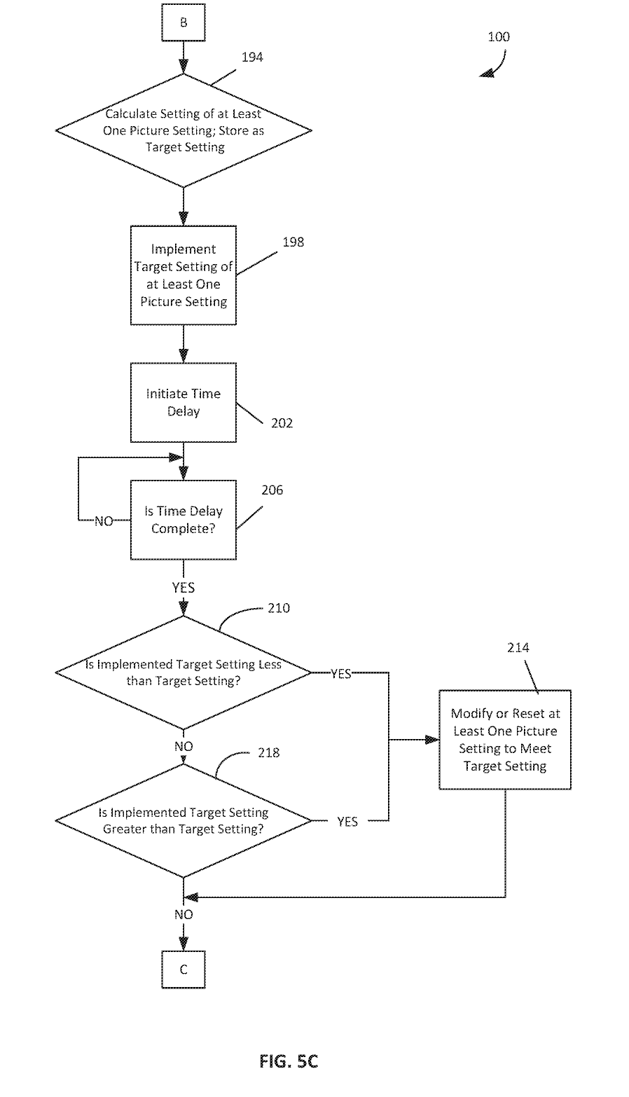

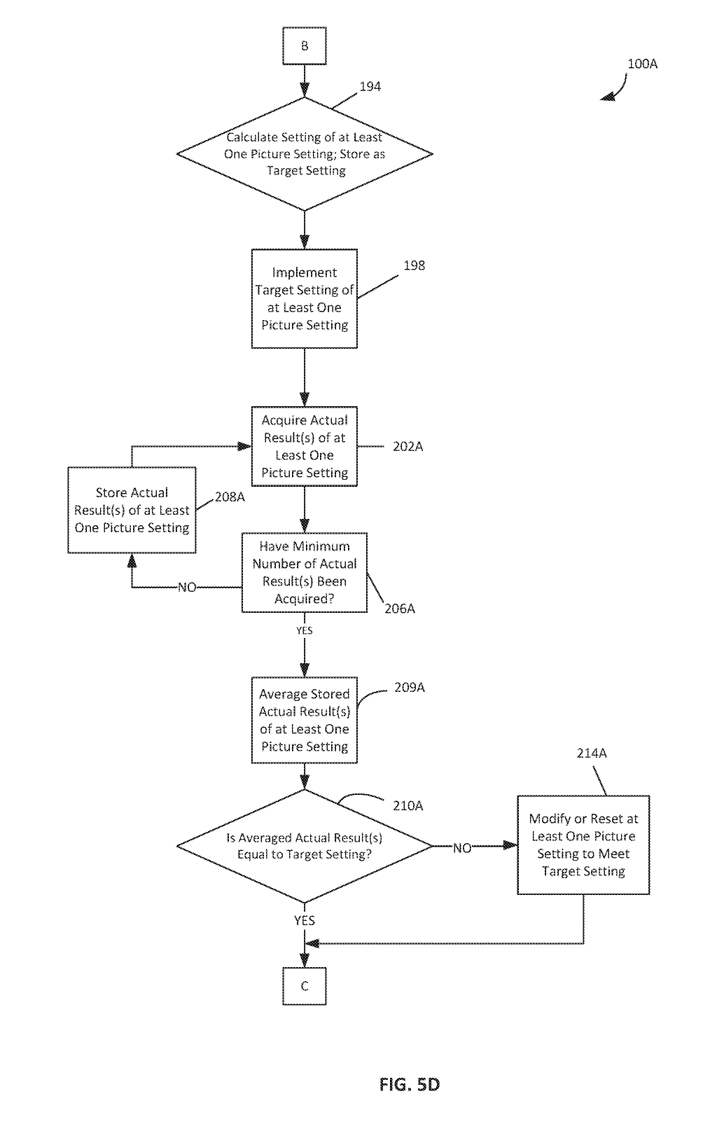

FIGS. 5A-5C illustrate an example of the automatic picture adjustment system 100 that uses light condition information acquired from the light monitoring sensor 34 to adjust at least one setting of the display 92 of the outdoor television 10. More specifically, the automatic picture adjustment system 100 detects ambient light conditions, and in response to the detected ambient light conditions, can separately adjust the backlight brightness and/or at least one picture setting of the display 92. It should be appreciated that automatic adjustment of the backlight brightness and of at least one picture setting of the display 92 are separate and independent processes. As such, both processes can operate concurrently, or optionally, one or both of the processes can be disabled by a user (e.g., a user can enable or disable one or both of the processes in a setup menu of the outdoor television 10). FIG. 5A describes an embodiment of the automatic adjustment of the backlight brightness to adjust the brightness of the display 92, while FIGS. 5B-5C describe an embodiment of the automatic adjustment of at least one picture setting of the display 92. In the illustrated embodiment, the automatic picture adjustment system 100 is carried by and operable on the microprocessor 64 of the outdoor television 10. For example, the automatic picture adjustment system 100 can be saved and/or executed (or implemented or otherwise operable) on the firmware of the microprocessor 64. In other embodiments, the automatic picture adjustment system 100 can be saved and/or is operable on any associated or suitable component of the outdoor television 10 (e.g., can be a module that operates on, or in association with, the outdoor television 10). The automatic picture adjustment system 100 includes a series of processing instructions or steps that are depicted in flow diagram form.

Referring to FIG. 5A, the process begins at step 104 with the outdoor television 10 being powered on. Once the outdoor television 10 is operating, the system 100 will determine at step 108 whether the automatic adjustment of the backlight brightness (also referred to as automatic backlight adjustment) of the display 92 is enabled. If no, the automatic backlight adjustment is not enabled, the process returns to step 108 to await activation (or enabling) of the automatic backlight adjustment. If yes, the automatic backlight adjustment is enabled, the process proceeds to step 112.

At step 112 the system 100 acquires a measured level of ambient light from the light monitoring sensor 34 (e.g., the photocell 34, etc.). The measured level of ambient light can then be converted to an appropriate value that is usable by the microprocessor 64 at step 116. For example, in the illustrated embodiment, the signal conditioning circuit 72 receives the resistance generated by the photocell 34, and then converts the resistance into a voltage, followed by the analog-to-digital convertor 76 receiving the voltage generated by the signal conditioning circuit 72, and then converting the voltage into an 8-bit digital value for use by the microprocessor 64. It should be appreciated that in other embodiments of the system 100, step 116 can be optional (e.g., when the ambient light monitoring sensor 34 generates a measurement value that is usable without further conversion by the microprocessor 64, etc.), or can include any additional or alternative steps (e.g., one or both of the signal conditioning circuit 72 and/or analog-to-digital convertor 76 can be omitted, etc.) needed to place the measured level of ambient light from the light monitoring sensor 34 in a format that is usable by the microprocessor 64.

Next at step 120, the measured level of ambient light, which is converted in an 8-bit digital value in this embodiment, is analyzed by the system to determine if it is below (or less than) a minimum level. The minimum level is a lower limit set point. The set point can be a preset set point, and/or can be adjustable by a user (e.g., in the settings menu of the outdoor television 10, etc.). In the illustrated embodiment, the lower limit set point is set at a zero (0) 8-bit digital value from the light monitoring sensor 34. However, in other embodiments, the lower limit set point can be any value suitable to act as a lower limit set point. If the measured level of ambient light is below (or less than) the lower limit set point (i.e., “yes” in response to step 120), the system 100 proceeds to step 124 and implements a low level backlight control. The low level backlight control is a preset control parameter for control of the backlight. The low level backlight control can be preloaded, and/or adjustable by the user (e.g., in the settings menu of the outdoor television 10, etc.). In the illustrated embodiment, the low level backlight control is set at a 0% increase in backlight output. Accordingly, the microprocessor 64 does not increase the illumination of the backlight 80 (e.g., the backlight 80 is not brightened), and the process returns to step 112. If the measured level of ambient light is not below (or is greater than) the lower limit set point (i.e., “no” in response to step 120), the system 100 proceeds to step 128.

At step 128 the measured level of ambient light, which is converted in an 8-bit digital value in this embodiment, is analyzed by the system to determine if it is above (or greater than) a maximum level. The maximum level is an upper limit set point. The set point can be a preset set point, and/or can be adjustable by a user (e.g., in the settings menu of the outdoor television 10, etc.). In the illustrated embodiment, the upper limit set point is set at a 160 8-bit digital value from the light monitoring sensor 34. However, in other embodiments, the upper limit set point can be any value suitable to act as a upper limit set point. If the measured level of ambient light is above (or move than) the upper limit set point (i.e., “yes” in response to step 120), the system 100 proceeds to step 132 and implements a high level backlight control. The high level backlight control is a preset control parameter for control of the backlight. The high level backlight control can be preloaded, and/or adjustable by the user (e.g., in the settings menu of the outdoor television 10, etc.). In the illustrated embodiment, the low level backlight control is set at 100% (or maximum) level of operation of the backlight output. Accordingly, the microprocessor 64 increases the illumination of the backlight 80 (e.g., the backlight 80 is brightened) to its maximum setting (e.g., the microprocessor 64 instructs the backlight 80, through the backlight inverter 84, to operate at the maximum setting, etc.), and the process returns to step 112. If the measured level of ambient light is not above (or is less than) the upper limit set point (i.e., “no” in response to step 128), the system 100 proceeds to step 136.

At step 136, the measured level of ambient light, which is converted in an 8-bit digital value in this embodiment, is determined to be between the lower limit set point and the upper limit set point. The microprocessor 64 then calculates a level of backlight control. The calculation is based on a linear correlation between the lower limit set point and the upper limit set point. For example, in this embodiment, the linear correlation is based on a 0% increase in illumination at a zero (0) 8-bit digital value from the light monitoring sensor 34, and a 100% level of operation (or maximum operational setting) at a 160 or above 8-bit digital value from the light monitoring sensor 34. This linear correlation results in a factor of 0.625 (e.g., the slope of the linear correlation), and thus a calculation of the measured level of ambient light, in 8-bit digital value from the light monitoring sensor 34, multiplied by 0.625. It should be appreciated that the factor is provided for purposes of illustration, and in other embodiments, can be a different number based on the lower and upper limit set points.

This calculated level of backlight control, which can increase or decrease backlight brightness in response to the measured level of ambient light, is then implemented at step 140. The microprocessor 64 instructs the backlight 80, through the backlight inverter 84, to operate at the calculated level of brightness control. This results in an increase in backlight brightness (or illumination), a decrease in backlight brightness (or illumination), or no change in backlight brightness (or illumination). The system 100 then returns to step 112, where the steps can repeat.

Referring now to FIG. 5B, the system 100 will determine at step 150 whether the automatic adjustment of the at least one picture setting of the display 92 is enabled. Step 150 can occur concurrently, alternatively, or in any suitable order relative to the steps associated with the automatic adjustment of the backlight brightness (also referred to as automatic backlight adjustment), and after the outdoor television 10 being powered on at step 104. If no, the automatic adjustment of the at least one picture setting is not enabled at step 150, the process returns to step 150 to await activation (or enabling) of the automatic adjustment of the at least one picture setting. If yes, the automatic adjustment of the at least one picture setting is enabled, the process proceeds to step 154. It should be appreciated that the at least one picture setting of the display can include, but is not limited to, contrast, display brightness, sharpness, tint, and/or color. While aspects of the disclosure herein will refer to contrast for purposes of illustration, the system 100 is not limited in any way to adjusting only contrast.

At step 154, the system 100 can reset a counter. The counter is any suitable system for counting data points. In the illustrated embodiment, the counter is depicted as a counter that is used in association with data points. In other embodiments, the counter can be integrated into a database, such as a window for detecting a moving average (i.e., averaging the last N number of data points, with N being an integer, etc.). As such, the counter and associated reset of the counter in step 154 can be an optional step.

Next, at step 158, the system 100 acquires a measured level of ambient light from the light monitoring sensor 34 (e.g., the photocell 34, etc.). The measured level of ambient light can then be converted to an appropriate value that is usable by the microprocessor 64 at step 162. The acquisition and conversion steps 158, 162 are substantially the same as respective steps 112, 116.

At step 166, the system determines whether a minimum number of measured levels of ambient light have been acquired from the light monitoring sensor 34. A minimum number of measurements are needed in order to generate an average measured level of ambient light value. If no, there are insufficient data points to generate a suitable average (e.g., the counter has not identified sufficient data points, etc.), the acquired measured level of ambient light is stored at step 170. Then, at step 172, the counter is adjusted to account for the data point (e.g., the counter can count up, count down, etc.) before returning to step 158 to acquire additional data points. If yes, the minimum number of measured data points has been acquired, the system 100 proceeds to step 174 to average the acquired (and stored) measured levels of ambient light. In the illustrated embodiment, the system 100 can require a different number of values to form an average measured level of ambient light. For example, in a full high definition (or FHD) display (e.g., 1080p), the system 100 can require a minimum of ten (10) values of the measured level of ambient light acquired from the light monitoring sensor 34 to calculate an average. As another example, in a ultra-high definition (or UHD) display (e.g., 4K), the system 100 can require a minimum of five (5) values of the measured level of ambient light acquired from the light monitoring sensor 34 to calculate an average. In other embodiments, the system 100 can average any suitable number of values of the measured level of ambient light acquired from the light monitoring sensor 34, or does not need to average any values. It should also be appreciated that the average can be a moving average, or an average of discrete, non-overlapping data points.

Once the average is calculated, the system 100 proceeds to step 178 where the measured level of ambient light, which is converted in an 8-bit digital value in this embodiment, is analyzed by the system 100 to determine if it is below (or less than) a minimum level. The minimum level is a lower limit set point. The set point can be a preset set point, and/or can be adjustable by a user (e.g., in the settings menu of the outdoor television 10, etc.). In the illustrated embodiment, the lower limit set point is a minimum value for the at least one picture setting of the display (e.g., a minimum contrast level, etc.). The lower limit set point can be any value suitable to act as a lower limit set point. If the averaged measured level of ambient light is below (or less than) the lower limit set point (i.e., “yes” in response to step 178), the system 100 proceeds to step 182 and implements a minimum setting of at least one picture setting. The minimum setting is a preset control parameter for control of the picture that is optimized (or desired) for a low ambient light condition to maximize image quality. The minimum setting can be preloaded, and/or be adjustable by the user (e.g., in the settings menu of the outdoor television 10, etc.). In the illustrated embodiment, the minimum setting is implemented by the microprocessor 64, where the microprocessor 64 applies the one or more picture settings based on the minimum setting to the video signal transmitted to the timing control board 92, which then implements the video signal to the formal format for control by the liquid crystals of the display 88. The system 100 can then return to step 154. If the measured level of ambient light is not below (or is greater than) the lower limit set point (i.e., “no” in response to step 120), the system 100 proceeds to step 186.

At step 186, the measured level of ambient light, which is converted in an 8-bit digital value in this embodiment, is analyzed by the system 100 to determine if it is above (or greater than) a maximum level. The maximum level is an upper limit set point. The set point can be a preset set point, and/or can be adjustable by a user (e.g., in the settings menu of the outdoor television 10, etc.). In the illustrated embodiment, the upper limit set point is a maximum value for the at least one picture setting of the display (e.g., a maximum contrast level, etc.). The upper limit set point can be any value suitable to act as an upper limit set point. If the averaged measured level of ambient light is above (or greater than) the upper limit set point (i.e., “yes” in response to step 186), the system 100 proceeds to step 190 and implements a maximum setting of at least one picture setting. The maximum setting is a preset control parameter for control of the picture that is optimized (or desired) for a high ambient light condition to maximize image quality. The maximum setting can be preloaded, and/or adjustable by the user (e.g., in the settings menu of the outdoor television 10, etc.). In the illustrated embodiment, the maximum setting is implemented by the microprocessor 64, where the microprocessor 64 applies the one or more picture settings based on the minimum setting to the video signal transmitted to the timing control board 92, which then implements the video signal to the formal format for control by the liquid crystals of the display 88. The system 100 can then return to step 154. If the measured level of ambient light is not above (or is less than) the upper limit set point (i.e., “no” in response to step 186), the system 100 proceeds to step 194, which is shown in FIG. 5C.

Referring now to FIG. 5C, the system 100 calculates a setting of at least one picture setting in step 194. The calculation is based on the following formula: (average measured level of ambient light value (calculated in step 174) minus the lower limit set point (step 178)) multiplied by (the maximum setting (step 182) minus the minimum setting (step 190)). This total is divided by (the upper limit set point (step 186) minus the lower limit set point (step 178)), and then added to the minimum setting (step 190). The calculated setting of at least one picture setting is then stored as a target setting(s), before being implemented by the microprocessor 64 at step 198, where the microprocessor 64 applies the one or more picture settings based on the calculated setting to the video signal transmitted to the timing control board 92, which then implements the video signal to the formal format for control by the liquid crystals of the display 88.

Next, at step 202, the system 100 implements a time delay (i.e., a timer) before determining if the implemented calculated setting of at least one picture setting changed the picture quality of meet the target setting. In the illustrated embodiment, the time delay is 200 milliseconds. However, in other embodiments, the time delay can be any suitable or desired amount of time. At step 206, the system 100 determines if the time delay has elapsed. If no, the time has not elapsed, the system 100 returns to step 206 until the time delay is complete. If yes, the time has elapsed, the system 100 proceeds to step 210.

At steps 210-218, the system 100 evaluates the implemented at least one picture setting to determine whether the picture meets the target setting. At step 210, the system 100 analyzes the picture to determine whether the setting(s) are less than the target setting(s). If the implemented setting(s) are less than the target setting(s) (i.e., “yes” in response to step 210), the system 100 modifies (or resets or otherwise adjusts) the at least one picture setting to meet the target setting (e.g., the microprocessor 64 adjusts the one or more picture settings to the video signal transmitted to the timing control board 92) at step 214. If the implemented setting(s) are not less than the target setting(s) (i.e., “no” in response to step 210), the process proceeds to step 218. At step 218, the system 100 analyzes the picture to determine whether the setting(s) are greater than the target setting(s). If the implemented setting(s) are greater than the target setting(s) (i.e., “yes” in response to step 218), the system 100 modifies (or resets or otherwise adjusts) the at least one picture setting to meet the target setting (e.g., the microprocessor 64 adjusts the one or more picture settings to the video signal transmitted to the timing control board 92) at step 214. If the implemented setting(s) are not greater than the target setting(s) (i.e., “no” in response to step 210), the system 100 returns to step 154 (see FIG. 5B) where the process can repeat.

It should be appreciated that the embodiment illustrated in FIG. 5C is for use with a full high definition (or FHD) display (e.g., 1080p). FIG. 5D illustrates an embodiment of the system 100A for use with a ultra-high definition (or UHD) display (e.g., 4K). It should be appreciated that the system 100 and 100A are generally the same, as illustrated in FIGS. 5A-5B, with differences between FIGS. 5C and 5D being noted below. As such, like numbers will identify like steps.

With reference to FIG. 5D, the system 100A proceeds with steps 194 and 198, which are substantially the same as discussed above in association with system 100 in FIG. 5C. After implementing the target setting at step 198, system 100A proceeds to step 202A. At step 202A, the system 100A acquires the actual results of the at least one picture setting from the display 88. At step 206A, the system 100A determines whether a minimum number of actual results have been acquired. If the minimum number of results have not been acquired (i.e., “no” in response to step 206A), the system 100A stores the acquired actual result, and returns to step 202A to acquire additional actual results from the display 88. If the minimum number of results have been acquired (i.e., “yes” in response to step 206A), the system 100A proceeds to step 209A to average the stored actual results of the at least one picture setting from the display 88. In the illustrated embodiment, the system 100A can require a minimum of five (5) values of the actual results of the at least one picture setting from the display 88 to calculate an average. In other embodiments, the system 100A can average any suitable number of actual results of the at least one picture setting from the display 88, or does not need to average any values. It should also be appreciated that the average can be a moving average, or an average of discrete, non-overlapping data points.

Next at step 210A, the averaged actual results of the at least one picture setting from the display 88 are analyzed with regard to the target setting(s) (from step 194). If the average actual results do not equal the target setting(s) (i.e., “no” in response to step 210A), the system 100A proceeds to step 214A, where the system 100A modifies (or resets or otherwise adjusts) the at least one picture setting to meet the target setting (e.g., the microprocessor 64 adjusts the one or more picture settings to the video signal transmitted to the timing control board 92). If the average actual results does equal the target setting(s) (i.e., “yes” in response to step 210A), the system 100A returns to step 154 (see FIG. 5B) where the process can repeat.

The performance of the automatic picture adjustment system 100 has been verified using an outdoor television 10 (a SEURA brand STRM-55.3-UB FHD display) that integrates the system 100, along with an incandescent light bulb that was wired to a dimmer switch. The light bulb was directed towards the light monitoring sensor 34 of the outdoor television 10, and 21 data points were acquired, with each data point correlating to an illumination from 0% to 100%, in 5% increments. Using the formula provided below, where Y % is the average percentage difference in luminance across the full grayscale range, Y₂₃₀ is the measured luminance when the average sampled light sensor readings is equal to 230 (the 8-bit digital value), Y₂₂₃ is the measured luminance when the average sampled light sensor readings is equal to 223 (the 8-bit digital value), and n is the index of the data sample. Accordingly, Yₙ is the measured luminance in response to a video signal with a grayscale percentage of 5n, resulting in an average increase in brightness of 30.87% while maintaining image quality.

$${Y}_{\%} = \frac{{\sum }_{n = 0}^{20} \frac{{Y}_{{230}_{n}} - {Y}_{{223}_{n}}}{{Y}_{{223}_{n}}}}{n + 1} * 100 \%$$

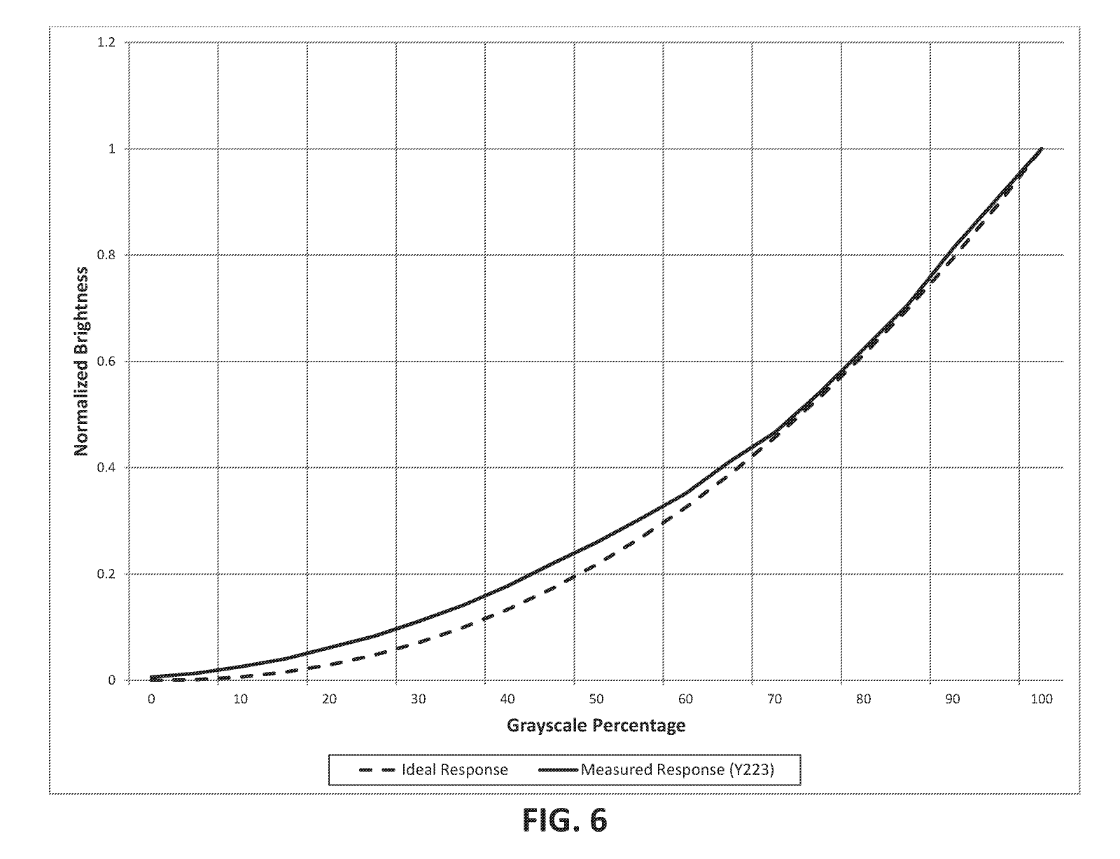

The results of the performance test are illustrated in FIG. 6, which illustrates normalized panel brightness (Y-axis) versus grayscale percentage (X-axis). The ideal response is illustrated in broken line, while the measured response according to Y₂₂₃ is illustrated in solid line. The response value for Y₂₂₃ was chosen as a reference because the higher average sampled light sensor readings (e.g., over 160, etc.) produce clipping (or saturation) of the display 88.

The outdoor television 10 and incorporating the automatic picture adjustment system 100, 100A discloses herein has certain advantages. For example, the system 100, 100A provides for automatic independent or concurrent adjustment of backlight brightness (or backlight intensity) and at least one picture setting (e.g., picture contrast, display brightness, sharpness, tint, and/or color) in response to detected ambient light conditions. This allows the outdoor television 10 to automatically increase brightness in high light condition (e.g., operation in direct sunlight) while minimizing adverse effects on image quality by adjusting at least one or more picture settings. Further, the outdoor television 10 can automatically adjust backlight brightness and at least one or more picture settings in response to changing light conditions (e.g., sunny to overcast conditions, daylight to dusk to nighttime, etc.) to provide adequate brightness (or brightness level) while minimizing negative affects to image or picture quality. These and other advantages are realized by the disclosure herein and the claims listed below.

Various additional features and advantages of the invention are set forth in the disclosure above and the following claims.

What is claimed is:

1. An outdoor television comprising:
a light monitoring sensor configured to measure an ambient light intensity, the light monitoring sensor in operable communication with a microprocessor;
a display in operable communication with the microprocessor; and
a video source in operable communication with the microprocessor,
wherein in response to the measured ambient light intensity, the microprocessor adjusts at least one picture setting of the display, the at least one setting picture setting including one of a contrast, a sharpness, a display brightness, a tint, or a color.

2. The outdoor television of claim 1, further comprising a backlight that is in operable communication with the microprocessor, the backlight is configured to control a backlight brightness, wherein in response to the measured ambient light intensity, the microprocessor instructs the backlight to adjust an intensity of light emitted by the backlight.

3. The outdoor television of claim 2, wherein in response to an increase in measured ambient light intensity, the microprocessor instructs the backlight to increase the intensity of light emitted by the backlight.

4. The outdoor television of claim 3, wherein in response to a decrease in measured ambient light intensity, the microprocessor instructs the backlight to decrease the intensity of light emitted by the backlight.

5. The outdoor television of claim 1, wherein the light monitoring sensor is a photocell.

6. The outdoor television of claim 5, further comprising a signal conditioning circuit in operable communication with the photocell, the signal conditioning circuit configured to receive a resistance generated by the photocell that corresponds to measured ambient light intensity, and further convert the resistance to a voltage.

7. The outdoor television of claim 6, further comprising an analog-to-digital convertor in operable communication with the signal conditioning circuit, the analog-to-digital convertor configured to receive the voltage from the signal conditioning circuit, and further convert the voltage to an 8-bit digital value.

8. The outdoor television of claim 7, wherein the microprocessor is in operable communication with the analog-to-digital convertor, the microprocessor configured to receive the 8-bit digital value from the analog-to-digital convertor.

9. The outdoor television of claim 1, wherein the display is a liquid crystal display.

10. An outdoor television comprising:
a light monitoring sensor configured to measure an ambient light intensity, the light monitoring sensor in operable communication with a microprocessor;
a display in operable communication with the microprocessor; and
a video source in operable communication with the microprocessor,
wherein in response to the measured ambient light intensity, the microprocessor adjusts at least one picture setting of the display.

11. The outdoor television of claim 10, wherein the at least one picture setting of the display is one of a contrast, a sharpness, a display brightness, a tint, or a color.

12. The outdoor television of claim 10, further comprising a backlight that is in operable communication with the microprocessor, the backlight is configured to control the brightness of the display, wherein in response to the measured ambient light intensity, the microprocessor instructs the backlight to adjust an intensity of light emitted by the backlight to adjust the brightness of the display.

13. The outdoor television of claim 12, wherein in response to an increase in measured ambient light intensity, the microprocessor instructs the backlight to increase the intensity of light emitted by the backlight.

14. The outdoor television of claim 13, wherein in response to a decrease in measured ambient light intensity, the microprocessor instructs the backlight to decrease the intensity of light emitted by the backlight.

15. The outdoor television of claim 11, wherein to adjust at least one picture setting of the display, the microprocessor applies the adjustment of the at least one picture setting to a video provided by the video source, and transmits the adjusted video to the display.

16. The outdoor television of claim 15, wherein the microprocessor transmits the adjusted video to a timing control board, and the timing control board transmits the adjusted video to the display.

17. The outdoor television of claim 10, wherein the display is a liquid crystal display.

18. The outdoor television of claim 10, wherein the light monitoring sensor is a photocell.

19. The outdoor television of claim 12, wherein in response to the measured ambient light intensity, the microprocessor adjusts one of the at least one picture setting of the display or the backlight of the display.
